(19) United States
(12) Patent Application Publication
(10) Pub. No.: US 2026/0247497 A1
(43) Pub. Date: Aug. 20, 2026

(54) WIRING SHEET

(71) Applicant: LINTEC Corporation, Tokyo (JP)

(72) Inventors: Takuya OSHIMA, Tokyo (JP); Masaharu ITO, Tokyo (JP)

(21) Appl. No.: 18/851,489

(22) PCT Filed: Mar. 30, 2022
(86) PCT No.: PCT/JP2022/016038

§ 371 Date: Sep. 26, 2024

(51) Int. Cl. H05B 3/34

(52) U.S. Cl. CPC H05B 3/342; H05B 2203/011

(57) ABSTRACT

A wiring sheet includes a pseudo sheet structure including conductive linear bodies arranged at intervals; and a pair of electrodes-being in direct contact with the conductive linear bodies, in which a Young's modulus of the electrodes is in a range of more than 1×10⁹ Pa to 100×10⁹ Pa or less.

### TECHNICAL FIELD

The present invention relates to a wiring sheet.

### BACKGROUND ART

A known wiring sheet includes a pseudo sheet structure in which a plurality of metal wires are arranged at intervals. The wiring sheet is usable, for instance, as a material of a textile that generates heat, a member that causes a variety of articles to generate heat, and a heat-generating body in a heat-generating device.

As a sheet for use as a heat-generating body, for instance, Patent Literature 1 describes a sheet including a pseudo sheet structure in which a plurality of linear bodies extending in one direction are arranged at intervals. A wiring sheet usable as a heat-generating body is obtained by providing a pair of electrodes on opposite end portions of the plurality of linear bodies.

### CITATION LIST

### Patent Literature(s)

Patent Literature 1: International Publication No. WO 2017/086395

### SUMMARY OF THE INVENTION

### Problem(s) to be Solved by the Invention

However, in the sheet described in Patent Literature 1, a resistance value of the wiring sheet was found to be higher than a calculated value due to a contact resistance between the conductive linear bodies and the electrodes.

An object of the invention is to provide a wiring sheet having a reduced contact resistance between conductive linear bodies and electrodes.

### Means for Solving the Problem(s)

According to an aspect of the invention, there is provided a wiring sheet including: a pseudo sheet structure including a plurality of conductive linear bodies arranged at intervals; and a pair of electrodes being in direct contact with the conductive linear bodies, in which a Young's modulus of the electrodes is in a range of more than 1×10⁹ Pa to 100×10⁹ Pa or less.

In the wiring sheet according to the aspect of the invention, a relationship between an axial resistance value R of the electrodes and an axial resistance value r for all the conductive linear bodies preferably satisfies a condition represented by an expression (F1) below.

$$r > R \qquad ( F 1 )$$

In the wiring sheet according to the aspect of the invention, the electrodes preferably have a thickness of 40 μm or less.

In the wiring sheet according to the aspect of the invention, the electrodes are preferably gold-plated.

In the wiring sheet according to the aspect of the invention, the electrodes preferably consist of a conductor having a Young's modulus in the range of more than 1×10⁹ Pa to 100×10⁹ Pa or less.

Preferably, the wiring sheet according to the aspect of the invention further includes a resin layer supporting the pseudo sheet structure.

Preferably, the wiring sheet according to the aspect of the invention further includes a base material supporting the pseudo sheet structure.

According to another aspect of the invention, there is provided a method of producing the wiring sheet according to the above aspect of the invention, the method including: forming the pair of electrodes on the pseudo sheet structure such that the pair of electrodes are in direct contact with the conductive linear bodies, the pair of electrodes including a conductor having a Young's modulus in a range of more than 1×10⁹ Pa to 100×10⁹ Pa or less.

According to the aspects of the invention, there is provided a wiring sheet having a reduced contact resistance between conductive linear bodies and electrodes.

### BRIEF DESCRIPTION OF DRAWINGS

FIG. 1 schematically illustrates a wiring sheet according to an exemplary embodiment of the invention.

FIG. 2 is a cross-sectional view illustrating a cross section along II-II in FIG. 1.

FIG. 3A illustrates a method of producing the wiring sheet according to the exemplary embodiment of the invention.

FIG. 3B illustrates the method of producing the wiring sheet according to the exemplary embodiment of the invention.

FIG. 3C illustrates the method of producing the wiring sheet according to the exemplary embodiment of the invention.

FIG. 3D illustrates the method of producing the wiring sheet according to the exemplary embodiment of the invention.

### DESCRIPTION OF EMBODIMENT(S)

The invention will be described below with reference to exemplary embodiment(s) on the basis of the drawings. The scope of the invention is not limited to the disclosure of the exemplary embodiment(s). In the drawings, some parts are enlarged or reduced for ease of explanation.

### Wiring Sheet

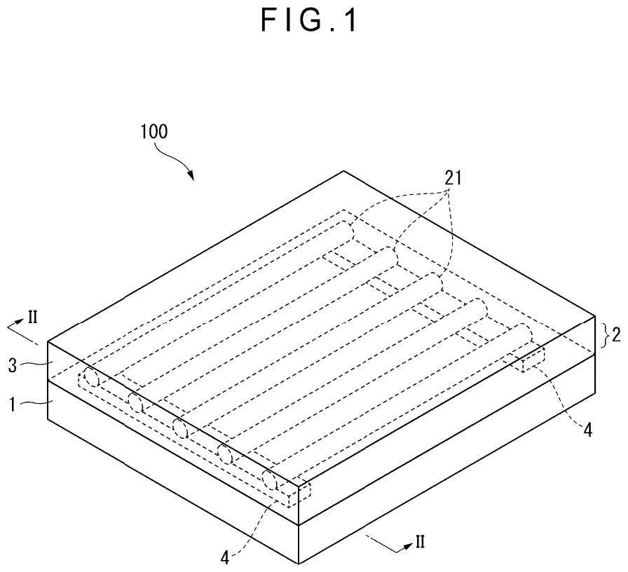

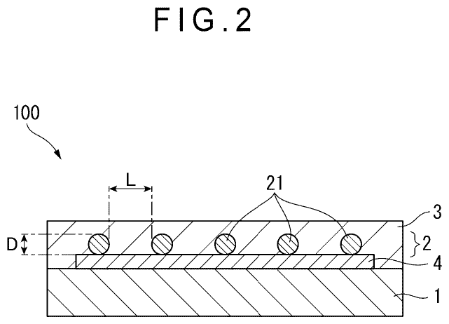

As illustrated in FIGS. 1 and 2, a wiring sheet 100 according to the exemplary embodiment includes a pseudo sheet structure 2 in which a plurality of conductive linear bodies 21 are arranged at intervals and a pair of electrodes 4. The pseudo sheet structure 2 is electrically connected to the electrodes 4.

The Young's modulus of the electrodes 4 is in a range of more than 1×10⁹ Pa to 100×10⁹ Pa or less.

Although not exactly clear, the inventors speculate a reason why a small contact resistance between the conductive linear bodies 21 and the electrodes 4 is achievable in the wiring sheet 100 according to the exemplary embodiment, as follows.

That is, it is speculated that the contact resistance between the conductive linear bodies 21 and the electrodes 4 is related to the ease of digging of the conductive linear bodies 21 into the electrodes 4 in a case where the conductive linear bodies 21 are compressed to be bonded to the electrodes 4. In a case where the electrodes 4 are excessively hard (the Young's modulus of the electrodes 4 is excessively high), the conductive linear bodies 21 hardly dig into the electrodes 4. In the wiring sheet 100 according to the exemplary embodiment, however, the Young's modulus of the electrodes 4 is within the above range, which causes the conductive linear bodies 21 to dig moderately into the electrodes 4. Accordingly, the inventors have speculated that the contact resistance between the conductive linear bodies 21 and the electrodes 4 is reducible.

### Base Material

A base material 1 can directly or indirectly support the pseudo sheet structure 2. The base material 1 is not necessarily provided. The base material 1 is a member that is provided as needed.

Examples of the base material 1 include a resin film, paper, metallic foil, nonwoven fabric, fabric, and glass.

Preferably, the base material 1 has transparency or visibility. Such a configuration can improve the light transmittance of the wiring sheet 100.

The base material 1 may also have stretchability. The stretchability of the base material 1 ensures the stretchability of the wiring sheet 100 even when the pseudo sheet structure 2 is provided on the base material 1.

Examples of the resin film include a polyethylene film, polypropylene film, polybutene film, polybutadiene film, polymethylpentene film, polyvinyl chloride film, vinyl chloride copolymer film, polyethylene terephthalate film, polyethylene naphthalate film, polybutylene telephthalate film, polyurethane film, ethylene-vinyl acetate copolymer film, ionomer resin film, ethylene-(meth)acrylic acid copolymer film, ethylene-(meth)acrylic ester copolymer film, polystyrene film, polycarbonate film, and polyimide film or cross-linked films and laminate films thereof.

Examples of the nonwoven fabric include spunbonded nonwoven fabric, needlepunched nonwoven fabric, melt-blown nonwoven fabric, and spunlace nonwoven fabric. Examples of the fabric include woven fabric and knit fabric. Examples of the glass include a glass plate, glass fiber, and glass film.

For the above reasons, the resin film, nonwoven fabric, fabric, or glass is preferable as the base material 1, the resin film or glass is more preferable, and the polyethylene terephthalate film or glass plate is still more preferable.

The thickness of the base material 1 is not particularly limited. The thickness of the base material 1 is preferably 10 μm or more, more preferably 15 μm or more, and still more preferably 50 μm or more. The thickness of the base material 1 is preferably 10 mm or less, more preferably 5 mm or less, and still more preferably 3 mm or less.

### Pseudo Sheet Structure

The pseudo sheet structure 2 has a structure in which the plurality of conductive linear bodies 21 are arranged at intervals. That is, the pseudo sheet structure 2 is a structure in which the plurality of conductive linear bodies 21 are arranged at interval to form a flat surface or a curved surface. The conductive linear bodies 21 unidirectionally extend and are in a straight shape or in a wavy shape in a plan view of the wiring sheet 100. In the pseudo sheet structure 2, the conductive linear bodies 21 are arranged in a plurality of rows in a direction orthogonal to an axial direction of the conductive linear bodies 21.

The conductive linear bodies 21 may be in a straight shape or in a wavy shape in a plan view of the wiring sheet 100. Examples of the wavy shape include a sinusoidal wave, rectangular wave, triangular wave, and saw-tooth wave. Such a structure of the pseudo sheet structure 2 can inhibit the conductive linear bodies 21 from breaking, when the wiring sheet 100 is stretched in the axial direction of the conductive linear bodies 21.

The volume resistivity of the conductive linear bodies 21 is preferably 1×10⁻⁹ Ω·m or more, more preferably 1×10⁻⁸ Ω·m or more. The volume resistivity of the conductive linear bodies 21 is preferably 1×10⁻³ Ω·m or less, more preferably 1×10⁻⁴ Ω·m or less. When the volume resistivity of the conductive linear bodies 21 is in the above range, the surface resistance of the pseudo sheet structure 2 is likely to decrease.

A method of measuring the volume resistivity of the conductive linear bodies 21 is as follows. A silver paste was applied to opposite end portions of the conductive linear body 21 and the resistance of a portion 300 mm from each end portion was measured. Then, a value, which is obtained by multiplying a cross-sectional area (unit: m²) of the conductive linear body 21 by the above resistance value, is divided by the above measured length (0.3 m) to calculate the volume resistivity of the conductive linear body 21.

The cross-sectional shape of the conductive linear body 21, which is not specifically limited, may be polygonal, flattened, elliptical, or circular. An elliptical shape or a circular shape is preferable in view of compatibility with the resin layer 3, or the like.

When the cross section of the conductive linear body 21 is circular, a thickness (diameter) D of the conductive linear body 21 (see FIG. 2) is preferably in a range of 3 μm to 75 μm. In order to restrain an increase in sheet resistance and improve heat generation efficiency and anti-insulation/breakdown properties when the wiring sheet 100 is used as a heat-generating body, the diameter D of the conductive linear body 22 is more preferably 5 μm or more, and still more preferably 8 μm or more. In addition, the diameter D of the conductive linear body 21 is more preferably 60 μm or less, still more preferably 40 μm or less, and still further more preferably 25 μm or less.

When the cross section of the conductive linear body 21 is elliptical, the major axis thereof is preferably in the same range as the diameter D described above.

The diameter D of the conductive linear body 21 is an average of diameters measured at randomly selected five points of the conductive linear bodies 21 of the pseudo sheet structure 2 through an observation using a digital microscope.

An interval L between the conductive linear bodies 21 (see FIG. 2) is preferably 0.3 mm or more, more preferably 0.5 mm or more, and still more preferably 0.8 mm or more. The interval L between the conductive linear bodies 21 is preferably 50 mm or less, more preferably 30 mm or less, and still more preferably 20 mm or less.

When the interval between the conductive linear bodies 21 falls within the above range, the conductive linear bodies are densely arrayed to some extent. This can enhance the performance of the wiring sheet 100 such as keeping the resistance of the pseudo sheet structure at a low level and providing uniform distribution in temperature rise when the wiring sheet 100 is used as a heat-generating body.

The interval L between the conductive linear bodies 21 is obtained by observing the conductive linear bodies 21 of the pseudo sheet structure 2 and measuring an interval between adjacent two of the conductive linear bodies 21 using a digital microscope.

It should be noted that the interval between adjacent two of the conductive linear bodies 21 herein refers to a length between facing parts of the two conductive linear bodies 21 in an arraying direction of the conductive linear bodies 21 (see FIG. 2). When the conductive linear bodies 21 are arrayed at uneven intervals, the interval L is an average of all intervals between adjacent ones of the conductive linear bodies 21.

The conductive linear body 21, of which structure is not specifically limited, may be a linear body including a metal wire (hereinafter also referred to as a “metal wire linear body”). The metal wire is excellent in heat conductivity, electrical conductivity, and handleability. The use of the metal wire linear body as the conductive linear body 21 facilitates the improvement in light transmissivity while reducing the resistance value of the pseudo sheet structure 2. Further, when the wiring sheet 100 (pseudo sheet structure 2) is used as a heat-generating body, heat is easily and quickly generated. Furthermore, a small-diameter linear body as described above is easily obtainable.

It should be noted that examples of the conductive linear body 21 include, in addition to the metal wire linear body, a linear body including a carbon nanotube and a linear body in a form of a conductively coated yarn.

The metal wire linear body may be a linear body made of a single metal wire or a linear body provided by spinning a plurality of metal wires.

Examples of the metal wire include wires containing metals, such as copper, aluminum, tungsten, iron, molybdenum, nickel, titanium, silver, and gold, or alloys containing two or more metals (e.g., steels such as stainless steel and carbon steel, brass, phosphor bronze, zirconium-copper alloy, beryllium copper, iron nickel, Nichrome, nickel titanium, KANTHAL, HASTELLOY, and rhenium tungsten). The metal wire may be plated with gold, tin, zinc, silver, nickel, chrome, nickel chrome alloy, solder, or the like, or may be surface-coated with a later-described carbon material or a polymer. Especially, a wire containing one or more metals selected from tungsten, molybdenum and alloys containing tungsten and/or molybdenum is preferable in terms of providing thin and high-strength conductive linear bodies 21 having a low volume resistivity.

It is particularly preferable that the metal wire be gold-plated. The gold-plating makes it possible to inhibit migration of the metal wire.

The metal wire may be coated with a carbon material. Coating the metal wire with a carbon material reduces metallic luster, making it easy for the metal wire to be less noticeable. Further, the metal wire coated with a carbon material is restrained from metal corrosion.

Examples of the carbon material usable for coating the metal wire include amorphous carbon (e.g., carbon black, active carbon, hard carbon, soft carbon, mesoporous carbon, and carbon fiber), graphite, fullerene, graphene, and a carbon nanotube.

The conductive linear body 21 may be a linear body in a form of a conductively coated yarn. Examples of the yarn include yarns made from resins, such as nylon and polyester, by spinning. Examples of the conductive coating include coating films of a metal, a conductive polymer, a carbon material, and the like. The conductive coating can be formed by plating, vapor deposition, or the like. The linear body in a form of a conductively coated yarn can be improved in conductivity of the linear body with flexibility of the yarn maintained. In other words, a reduction in resistance of the pseudo sheet structure 2 is facilitated.

### Resin Layer

The resin layer 3 is a layer containing a resin. The resin layer 3 can directly or indirectly support the pseudo sheet structure 2. The resin layer 3 is not necessarily provided. The resin layer 3 is a member that is provided as needed. The resin layer 3 is preferably a layer containing an adhesive agent. The conductive linear bodies 21 are easily attached to the resin layer 3 by an adhesive agent when the pseudo sheet structure 2 is formed in the resin layer 3. The resin layer 3 preferably has stretchability. The stretchable resin layer 3 can provide the stretchability of the wiring sheet 100.

When the resin layer 3 contains an adhesive agent, the adhesive agent applied to the resin layer 3 is not particularly limited. Examples of the usable adhesive agent include an adhesive agent with dry-solidification properties, an adhesive agent with hot-melting properties, an adhesive agent with curing properties (a curable adhesive agent), and an adhesive agent with pressure sensitivity. The adhesive agent with dry-solidification properties refers to an adhesive agent that solidifies by applying an adhesive agent composition and then removing moisture or a solvent therefrom by drying. The adhesive agent with curing properties refers to an adhesive agent that solidifies by applying an adhesive agent composition and drying it if needed, and then causing a chemical reaction. Examples of the adhesive agent with curing properties include (1) an adhesive agent that solidifies by a chemical reaction, such as a polymerization reaction, through at least one of a heat treatment or an energy-ray irradiation treatment, and (2) an adhesive agent that solidifies by reacting with moisture (water). The adhesive agent with hot-melting properties refers to an adhesive agent that melts when heated and adheres when cooled. The adhesive agent with pressure sensitivity is an adhesive agent (a sticky agent) that adheres through the viscosity of a sticky agent (a pressure-sensitive adhesive agent). Examples of the adhesive agent in the resin layer 3 also include an adhesive agent that exhibits stickiness when moistened or wetted.

The resin layer 3 may be a layer containing a sticky agent (a pressure-sensitive adhesive agent). The sticky agent in the sticky agent layer is not particularly limited. Examples of the sticky agent include an acrylic sticky agent, a urethane sticky agent, a rubber sticky agent, a polyester sticky agent, a silicone sticky agent, and a polyvinyl ether sticky agent. Among the above, the sticky agent is preferably at least one selected from the group consisting of an acrylic sticky agent, a urethane sticky agent, and a rubber sticky agent, more preferably an acrylic sticky agent.

Examples of the acrylic sticky agent include an acrylic polymer including a constituent unit derived from alkyl (meth)acrylate having a linear alkyl group or a branched alkyl group (i.e., a polymer with at least alkyl (meth)acrylate polymerized) and an acrylic polymer including a constituent unit derived from (meth)acrylate with a cyclic structure (i.e., a polymer with at least (meth)acrylate with a cyclic structure polymerized). Here, “(meth)acrylate” is used to refer to both of “acrylate” and “methacrylate” and the same applies to other similar terms.

The acrylic copolymer (including homopolymer and copolymer) may be cross-linked by a cross-linker. Examples of the cross-linker include an epoxy cross-linker, isocyanate cross-linker, aziridine cross-linker, and metal chelate cross-linker. In cross-linking the acrylic copolymer, for example, at least one of a hydroxyl group or a carboxyl group, which is reactive with the above cross-linkers, can be introduced into the acrylic copolymer as a functional group derived from a monomer component of the acrylic copolymer.

The resin layer 3 is not particularly limited. The resin layer 3 may be, for example, curable or non-curable. For example, the resin layer 3 may be curable or non-curable when the resin layer 3 contains an adhesive agent, or similarly, when the resin layer 3 contains a sticky agent. The resin layer 3 is preferably a curable resin layer in terms of allowing the resin layer 3 to form an outermost layer of the wiring sheet 100. A surface of the resin layer 3 easily has excellent scuff resistance by making the resin layer 3 a curable resin layer. In addition, the resin layer 3 is more preferably a curable resin layer with energy-ray curing properties in terms of simplicity of use. Examples of the curable resin layer with energy-ray curing properties include curable resin layers curable with energy rays such as ultraviolet light, visible light, infrared light, and electron beam. It should be noted that “curing with energy rays” includes thermosetting by energy-ray heating.

The curing herein does not refer merely to a reaction of a curable resin. Curing is a concept that may also include reducing the tackiness of the surface of the cured resin layer 3 (preferably eliminating the tackiness) and obtaining the excellent scuff resistance of the surface of the cured resin layer 3.

When the resin layer 3 constitutes the outermost layer of the wiring sheet 100, the resin layer 3 preferably has a small tackiness, more preferably no tackiness. Further, in terms of the above, the resin layer 3 is preferably a curable resin, more preferably an adhesive layer with curing properties that contains an energy-ray-curable resin.

The tackiness herein means stickiness that occurs on a surface of a material. The tackiness in the exemplary embodiment means stickiness that occurs on the surface of the resin layer 3.

When the resin layer 3 is a resin layer with energy-ray curing properties, the resin layer 3 may contain an energy-ray-curable resin. For example, when the resin layer 3 is a layer containing a sticky agent, the resin layer 3 is formed from, in addition to the sticky agent, a sticky agent composition containing an energy-ray-curable resin. Further, for example, when the resin layer 3 is a layer containing an adhesive agent, the resin layer 3 is formed from an adhesive agent composition containing an energy-ray-curable resin. Examples of the energy-ray-curable resin include a compound having at least one polymerizable double bond in a molecule. The compound having at least one polymerizable double bond in a molecule is preferably an acrylate compound having a (meth)acryloyl group. Examples of the acrylate compound include chain aliphatic skeleton-containing (meth)acrylate, cyclic aliphatic skeleton-containing (meth)acrylate, oligoester (meth)acrylate, urethane (meth)acrylate oligomer, epoxy-modified (meth)acrylate, polyalkylene glycol (meth)acrylate, polyether (meth)acrylate other than polyalkylene glycol (meth)acrylate, and oligomer itaconate. One of the energy-ray-curable resins may be contained alone or two or more thereof may be contained in combination. When two or more of the energy-ray-curable resins are contained, a combination and a ratio of the energy-ray-curable resins are selectable according to the purpose.

The weight-average molecular weight (Mw) of the energy-ray-curable resin is preferably 100 or more, more preferably 300 or more. Further, the weight-average molecular weight (Mw) of the energy-ray-curable resin is preferably 30,000 or less, more preferably 10,000 or less.

When the resin layer 3 is a resin layer with energy-ray curing properties, the energy-ray-curable resin and a later-described thermoplastic resin may be combined, and a combination and a ratio of the energy-ray-curable resin and the thermoplastic resin are selectable according to the purpose.

When the resin layer 3 is a thermosetting resin layer, the resin layer 3 contains a thermosetting resin. The thermosetting resin used in the resin layer 3 is not particularly limited. Specific examples of the thermosetting resin include an epoxy resin, phenol resin, melamine resin, urea resin, polyester resin, urethane resin, acrylic resin, benzoxazine resin, phenoxy resin, amine compound and acid anhydride compound. One of the thermosetting resins may be used alone, or two or more thereof may be used in combination. Among the above examples, in terms of suitability for curing with an imidazole curing catalyst, it is preferable to use, as the thermosetting resin, one of an epoxy resin, a phenol resin, a melamine resin, a urea resin, an amine compound, and an acid anhydride compound alone or two or more thereof. Particularly in terms of exhibiting excellent curability, it is preferable to use, as the thermosetting resin, an epoxy resin, a phenol resin, a mixture thereof, or a mixture of an epoxy resin and at least one selected from the group consisting of a phenol resin, melamine resin, urea resin, amine compound and acid anhydride compound.

When the resin layer 3 is a resin layer curable by moisture, the resin layer 3 contains a moisture-curing resin. The moisture-curing resin used in the resin layer 3 is not particularly limited. Examples thereof include a moisture-curing urethane resin (a resin produced by curing of an isocyanate group by moisture), and a modified silicone resin.

When at least one of the energy-ray-curable resin or the thermosetting resin is used, a photopolymerization initiator, a thermal polymerization initiator, or the like is preferably used for the resin layer 3. When the photopolymerization initiator or the like is used for the resin layer 3 containing the energy-ray-curable resin, a cross-linking structure is formed in the resin layer 3. When the thermal polymerization initiator or the like is used for the resin layer 3 containing the thermosetting resin, a cross-linking structure is formed in the resin layer 3. This makes it easier for the conductive linear bodies 21 to be more firmly protected by the resin layer 3.

Examples of the photopolymerization initiator include benzophenone, acetophenone, benzoin, benzoinmethylether, benzoinethylether, benzoinisopropylether, benzoinisobutylether, benzoin benzoic acid, benzoin methyl benzoate, benzoin dimethylketal, 2,4-diethyl thioxanthone, 1-hydroxy cyclohexylphenylketone, benzyl diphenyl sulfide, tetramethylthiuram monosulfide, azobisisobutyronitrile, 2-chloroanthraquinone, diphenyl(2,4,6-trimethylbenzoyl) phosphine oxide, and bis(2,4,6-trimethylbenzoyl)-phenyl-phosphine oxide.

Examples of the thermal polymerization initiator include hydrogen peroxide, peroxydisulfuric acid salts (e.g., ammonium peroxodisulfate, sodium peroxodisulfate, and potassium peroxodisulfate), azo compounds (e.g., 2,2′-azobis(2-amidinopropane)dihydrochloride, 4,4′-azobis(4-cyanovaleric acid), 2,2′-azobisiosbutyronitrile, and 2,2′-azobis(4-methoxy-2,4-dimethylvaleronitrile)), and organic peroxides (e.g., benzoyl peroxide, lauroyl peroxide, peracetic acid, persuccinic acid, di-t-butyl peroxide, t-butyl hydroperoxide, and cumene hydroperoxide).

One of the polymerization initiators may be used alone, or two or more thereof may be used in combination. When such a polymerization initiator(s) is used to form a cross-linking structure, the content of the polymerization initiator(s) is preferably 0.1 parts by mass or more, more preferably 1 part by mass or more with respect to 100 parts by mass of at least one of the energy-ray-curable resin or the thermosetting resin. Further, the content of the polymerization initiator(s) is preferably 100 parts by mass or less, more preferably 10 part by mass or less with respect to 100 parts by mass of at least one of the energy-ray-curable resin or the thermosetting resin.

The resin layer 3 is not necessarily a layer formed from a curable resin composition, and may be, for example, a layer formed from a thermoplastic resin composition. A thermoplastic resin layer can be softened by containing a solvent (water, flux, and the like) in the thermoplastic resin composition. The conductive linear bodies 21 are thus easily disposed on the resin layer 3 when the conductive linear bodies 21 are formed in the resin layer 3. Meanwhile, the thermoplastic resin layer can be dried and solidified by volatilizing the solvent in the thermoplastic resin composition.

Examples of the thermoplastic resin include polyethylene, polypropylene, polyvinyl chloride, polystyrene, polyvinyl acetate, polyurethane, polyether, polyethersulfone, polyimide, and acrylic resin. Examples of the solvent include an alcohol solvent, ketone solvent, ester solvent, ether solvent, hydrocarbon solvent, alkyl halide solvent, and water.

The resin layer 3 may contain an inorganic filler. The resin layer 3 containing the inorganic filler can have a further improved hardness after cured. In addition, the resin layer 3 containing the inorganic filler has an improved heat conductivity.

Examples of the inorganic filler include inorganic powder (e.g., powders of silica, alumina, talc, calcium carbonate, titanium white, colcothar, silicon carbide, metal, and boron nitride), beads of spheroidized inorganic powder, single crystal fiber, and glass fiber. Among the above, a silica filler and an alumina filler are preferable as the inorganic filler. One of the inorganic fillers may be used alone, or two or more thereof may be used in combination.

The resin layer 3 may contain other components. Examples of other components include known additives such as an organic solvent, a flame retardant, a tackifier, an ultraviolet absorber, an antioxidant, a preservative, an antifungal agent, a plasticizer, a defoamer, and a wettability modifier.

The thickness of the resin layer 3 is determined as needed depending on the intended use of the wiring sheet 100. For example, in view of adhesiveness, the thickness of the resin layer 3 is preferably 3 μm or more, more preferably 5 μm or more. Further, the thickness of the resin layer 3 is preferably 150 μm or less, more preferably 100 μm or less.

### Electrodes

The electrodes 4 are used to supply electric current to the conductive linear bodies 21. The electrodes 4 are in direct contact with the conductive linear bodies 21. The electrodes 4 are disposed in electrical connection on both end portions of the conductive linear bodies 21.

In the exemplary embodiment, the Young's modulus of the electrodes 4 needs to be in the range of more than 1×10⁹ Pa to 100×10⁹ or less.

When the Young's modulus of the electrodes 4 is 1×10⁹ Pa or less, the electrodes 4 are likely to be deformed, which may make their volume resistivity excessively high, and result in an excessively high resistance value of the electrodes 4. When the Young's modulus of the electrodes 4 exceeds 100×10⁹ Pa, the contact resistance between the conductive linear bodies 21 and the electrodes 4 cannot be reduced.

From a similar point of view, the Young's modulus of the electrodes 4 is preferably 10×10⁹ Pa or more, more preferably 20×10⁹ Pa or more, still more preferably 30×10⁹ Pa or more, and still further more preferably 50×10⁹ Pa or more. Furthermore, the Young's modulus of the electrodes 4 is preferably 90×10⁹ Pa or less, more preferably 80×10⁹ Pa or less, and still more preferably 70×10⁹ Pa or less.

The Young's modulus of the electrodes 4 is measurable by continuous stiffness measurement. Specifically, the Young's modulus is measurable by a method described later in Examples.

The electrodes 4 can be formed from a known electrode material having a Young's modulus in the above range. Examples of the electrode material include a conductive paste (e.g., silver paste) and a metal foil (e.g., solder alloy foil).

The electrodes 4 preferably consist of a conductor having a Young's modulus in the range of more than 1×10⁹ Pa to 100×10⁹ Pa or less. Such electrodes 4 more reliably reduce the contact resistance between the conductive linear bodies 21 and the electrodes 4. From a similar point of view, the electrodes 4 preferably consist of a conductor formed from a conductive paste.

Examples of the conductive paste include a silver paste, a copper paste, and a carbon paste. Among the above, the silver paste is preferable in terms of a low volume resistivity.

The electrodes 4 are preferably gold-plated. The gold-plating makes it possible to inhibit migration of the electrodes 4.

The width of one of the electrodes 4, in a plan view of the pseudo sheet structure 2, is preferably 10 mm or less, more preferably 5 mm or less, and still more preferably 3 mm or less. In addition, the lower limit of the width of the one of the electrodes 4 may be, for example, 0.1 mm or more.

The thickness of the electrodes 4 is preferably 40 μm or less, more preferably 30 μm or less, and still more preferably 20 μm or less. At a thickness of the electrodes 4 of the above upper limit or less, the deformation of the conductive linear bodies 21 resulting from bringing the conductive linear bodies 21 into contact with the electrodes 4 is small and electrical continuity tends to be stabilized. Further, the lower limit of the thickness of the electrodes 4 may be, for example, 1 μm or more.

A relationship between an axial resistance value R of the electrodes 4 and an axial resistance value r for all the conductive linear bodies 21 preferably satisfies a condition represented by an expression (F1) below.

$$r > R \qquad ( F 1 )$$

When the condition represented by the expression (F1) is satisfied, heat generation of the electrodes 4 can be reduced.

The value of R/r is preferably 0.0001 or more, more preferably 0.0005 or more. Further, R/r is preferably 0.3 or less, more preferably 0.0.15 or less. When the wiring sheet 100 is used as a heat-generating body, the pseudo sheet structure 2 to be heated needs to have some resistance. On the other hand, it is preferable for electric current to flow easily in the electrodes 4 as much as possible.

The axial resistance value R of the electrodes 4 and the axial resistance value r for all the conductive linear bodies 21 can be measured using a tester. First, the axial resistance value R of the electrodes 4 and an axial resistance value of each of the conductive linear bodies 21 are measured. Since the axial resistance value of the conductive linear body 21 is inversely proportional to the cross-sectional area of the conductive linear body 21, the axial resistance value r for all the conductive linear bodies 21 is calculated by dividing the axial resistance value of each conductive linear body 21 by the number of conductive linear bodies 21.

### Method of Producing Wiring Sheet

A method of producing a wiring sheet according to the exemplary embodiment will be described.

The wiring sheet 100 according to the exemplary embodiment described above can be produced by the method of producing a wiring sheet according to the exemplary embodiment. The method of producing a wiring sheet is not particularly limited.

The method of producing a wiring sheet according to the exemplary embodiment is exemplified by a method including forming the pair of electrodes 4 on the pseudo sheet structure 2 such that the pair of electrodes 4 are in direct contact with the conductive linear bodies 21, the pair of electrodes 4 including a conductor having a Young's modulus in a range of more than 1×10⁹ Pa to 100×10⁹ Pa or less (an electrode formation step).

Further, the method of producing a wiring sheet according to the exemplary embodiment may further include forming the pseudo sheet structure 2 (a pseudo sheet structure formation step). The wiring sheet 100 can be produced by performing the pseudo sheet structure formation step and the electrode formation step are performed in this order.

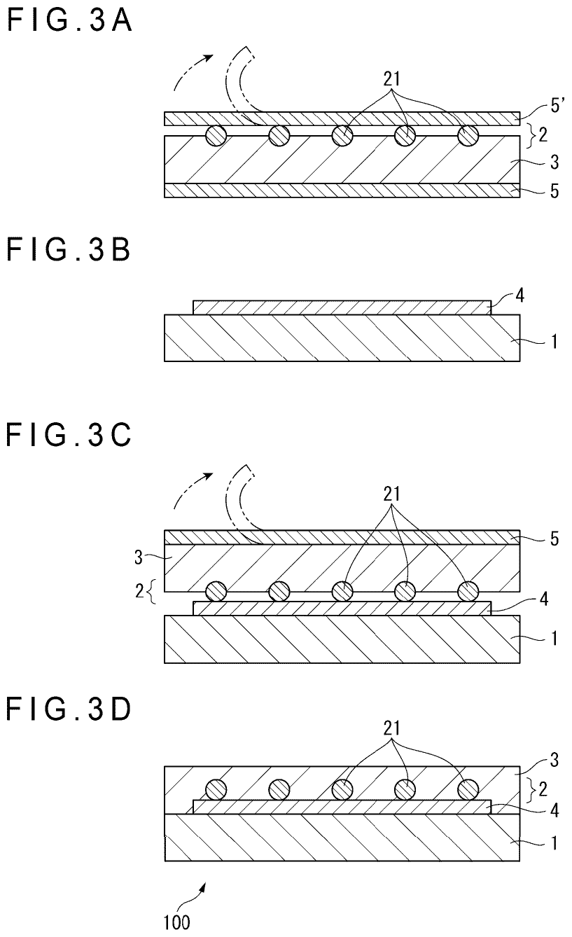

In the pseudo sheet structure formation step, an adhesive agent for forming the resin layer 3 is first applied to a release film 5 to form a coating film, as illustrated in FIG. 3A. The coating film is then dried to produce the resin layer 3. Subsequently, the conductive linear bodies 21 are arrayed and arranged on the resin layer 3 to form the pseudo sheet structure 2. For example, a drum member is rotated while the resin layer 3 with the release film 5 is disposed on an outer circumferential surface of the drum member, and the conductive linear bodies 21 are spirally wound on the resin layer 3 during the rotation of the drum member. After that, a bundle of the conductive linear bodies 21 spirally wound is cut along the axial direction of the drum member, resulting in the pseudo sheet structure 2 arranged on the resin layer 3. The resin layer 3 with the release film 5, on which the pseudo sheet structure 2 is formed, is removed from the drum member, and another release film 5′ is attached to the pseudo sheet structure 2, thereby obtaining a laminate including the pseudo sheet structure 2 as illustrated in FIG. 3A. According to this method, the interval L between adjacent ones of the conductive linear bodies 21 of the pseudo sheet structure 2 is easily adjusted by, for example, moving a feeder of the conductive linear bodies 21 along a direction parallel to the axis of the drum member while turning the drum member.

The release film 5, which is not particularly limited, may be a releasable film. The release film 5 may be, for example, a release sheet including a release base material and a release agent layer formed by coating the release base material with a release agent. The release agent layer provided on the release base material may be provided only on one surface of the release base material or on each of opposite surfaces of the release base material. Examples of the release base material include a paper base material, a laminated paper provided by laminating a thermoplastic resin on a base material such as paper or nonwoven fabric, and a thermoplastic resin film. Examples of the release agent include an olefin resin, rubber elastomer, long-chain alkyl resin, alkyd resin, fluorine resin, and silicone resin.

In the electrode formation step, one of the release films, the release film 5′, is first released from the laminate, as illustrated in FIG. 3A. Further, as illustrated in FIG. 3B, a belt-shaped conductive paste is applied to each of opposite end portions of the base material 1 and cured to form two electrodes 4, thereby forming the base material 1 with the electrodes 4.

Subsequently, as illustrated in FIG. 3C, the laminate from which one of the release films, the release film 5, is released is stuck on the base material 1 with the electrodes 4 such that the pair of electrodes 4 are disposed on the respective opposite end portions of the conductive linear bodies 21 of the pseudo sheet structure 2. Then, the other release film, the release film 5, is released.

As described above, the wiring sheet 100 as illustrated in FIG. 3D is produced.

### Working and Effect of Exemplary Embodiment

The exemplary embodiment enables the following working and effect.

(1) According to the exemplary embodiment, the Young's modulus of the electrodes 4 is in the range of more than 1×10⁹ Pa to 100×10⁹ Pa or less, which makes it possible to reduce the contact resistance between the conductive linear bodies 21 and the electrodes 4.

### Modifications of Exemplary Embodiment

The invention is not limited to the above exemplary embodiment, and modifications, improvements, etc. are within the scope of the invention as long as an object of the invention is achievable.

For example, the wiring sheet 100 includes the base material 1 in the above exemplary embodiment. The invention, however, is not limited thereto. For example, the wiring sheet 100 may not include the base material 1. In such a case, the wiring sheet 100 can be used by attaching it to an adherend through the resin layer 3.

### EXAMPLES

The invention will be described below in further detail with reference to Examples. The invention is by no means limited to these Examples.

### Preparation Example 1

An adhesive agent with curing properties was obtained by blending 100 parts by mass of a phenoxy resin (manufactured by Mitsubishi Chemical Corporation, trade name “YX7200B35”) with 170 parts by mass of a polyfunctional hydrogenated bisphenol A diglycidylether epoxy compound (manufactured by Mitsubishi Chemical Corporation, product name “YX8000”), 0.2 parts by mass of a silane coupling agent (manufactured by Shin-Etsu Chemical Co., Ltd., product name “KBM-4803”), 2 parts by mass of a thermal cation polymerization initiator (manufactured by SANSHIN CHEMICAL INDUSTRY CO., LTD., product name “SAN-AID SI-B3”), and 2 parts by mass of a thermal cation polymerization initiator (manufactured by SANSHIN CHEMICAL INDUSTRY CO., LTD., product name “SAN-AID SI-B7”).

### Example 1

### Production of Pseudo Sheet Structure

The adhesive agent obtained in Preparation Example 1 was applied to a to a 38-μm-thick release film (manufactured by LINTEC Corporation, trade name “SP-PET382150”) and dried to form a resin layer having a thickness of 15 μm after dried and cut into a 250 mm×320 mm rectangle, whereby an adhesive sheet was produced.

A gold-plated tungsten wire (10 μm in diameter, manufactured by TOKUSAI TungMoly Co., LTD., product name “Au(0.1)-TWG”, hereinafter referred to as “wire”) was prepared as conductive linear bodies.

Subsequently, the adhesive sheet was wound, without wrinkling, on a drum member having a rubber outer circumferential surface, with a surface of a pressure-sensitive adhesive agent layer facing outward. Opposite end portions of the adhesive sheet in the circumferential direction were fixed with a double-sided tape. The wire wound around a bobbin was attached to the surface of the pressure-sensitive adhesive agent layer of the adhesive sheet located near an end portion of the drum member. The wire was then unwound from the bobbin and wound around the drum member, and the drum member was gradually moved in a direction parallel to a drum axis, so that the wire was spirally wound around the drum member at equal intervals of 3 mm. In the above manner, a pseudo sheet structure was formed with 80 wires arranged on the surface of the adhesive agent layer. After that, the wire was cut and the pseudo sheet structure was removed from the drum member. The pseudo sheet structure was cut into a 40 mm×82 mm rectangle so that 12 of the wires were taken out, whereby a laminate with the pseudo sheet structure was produced.

Production of Base Material with Electrodes

A silver paste (manufactured by JUJO CHEMICAL CO., LTD., product name “#2 TF Silver Paste”) was screen-printed on a glass plate (2 mm in thickness) as a base material with a width of 2 mm and an interelectrode distance of 78 mm, and then dried under the conditions of 150 degrees C. and 30 minutes, forming two belt-shaped electrodes (resistance value: 0.74Ω) with a film thickness of 17 μm. Then, a nickel layer (thickness: 1 μm) and a gold layer (thickness: 50 nm) were laminated on the silver paste in this order by electroless plating to produce a base material with electrodes (resistance value: 0.56Ω).

### Production of Wiring Sheet

The resulting laminate was stuck on the base material with the electrodes, with the two electrodes positioned at the respective opposite end portions of the conductive linear bodies of the pseudo sheet structure, and then the release film was peeled off. After that, a wiring sheet was obtained by performing thermal compression bonding under the conditions of 120 degrees C., 0.5 MPa, and 30 minutes.

### Example 2

A wiring sheet was obtained as in Example 1 except that the belt-shaped electrodes were not subjected to electroless plating in the production of the base material with electrodes.

### Comparative Example 1

Production of Base Material with Electrodes

A copper foil (thickness: 18 μm, manufactured by JX Advanced Metals Corporation, product name “BHY-82F-HA”) with a 15 μm coating film of the adhesive agent obtained in Preparation Example 1 was stuck, with a width of 2 mm and an interelectrode distance of 70 mm, to a glass plate as a base material, and then the adhesive agent obtained in Preparation Example 1 was cured under the conditions of 120 degrees C. and 30 minutes to form two electrodes (resistance value: 0.04Ω), thereby producing a base material with electrodes.

### Production of Wiring Sheet

The adhesive agent obtained in Preparation Example 1 was applied to a to a 38-μm-thick release film (manufactured by LINTEC Corporation, trade name “SP-382150”) and dried to form a resin layer having a thickness of 15 μm after dried and cut into a 250 mm×320 mm rectangle, whereby an adhesive sheet was produced.

A gold-plated tungsten wire (12 μm in diameter, manufactured by TOKUSAI TungMoly Co., LTD., product name “Au(0.1)-TWG”, hereinafter referred to as “wire”) was prepared as conductive linear bodies.

Subsequently, the adhesive sheet was wound, without wrinkling, on a drum member having a rubber outer circumferential surface, with a surface of a pressure-sensitive adhesive agent layer facing outward. Opposite end portions of the adhesive sheet in the circumferential direction were fixed with a double-sided tape. The wire wound around a bobbin was attached to the surface of the pressure-sensitive adhesive agent layer of the adhesive sheet located near an end portion of the drum member. The wire was then unwound from the bobbin and wound around the drum member, and the drum member was gradually moved in a direction parallel to a drum axis, so that the wire was spirally wound around the drum member at equal intervals of 4 mm. In the above manner, a pseudo sheet structure was formed with 60 wires arranged on the surface of the adhesive agent layer. After that, the wire was cut and the pseudo sheet structure was removed from the drum member. The pseudo sheet structure was cut into a 36 mm×74 mm rectangle so that 8 of the wires were taken out, whereby a laminate with the pseudo sheet structure was produced.

### Evaluation of Resistance Value

A resistance meter was connected to the electrodes of the wiring sheet to measure a resistance value (actual measured value) of the wiring sheet. Then, a difference rate (unit: %) between the actual measured residence value and the calculated residence value was obtained from the following formula. Table 1 shows the results obtained.

Difference Rate Between Actual Measured Value and Calculated Value=[(Actual Measured Value−Calculated Value)/Calculated Value]×100(%)

Here, the calculated resistance value refers to a resistance value calculated from the resistance value and the number of conductive linear bodies and the resistance value of the electrodes.

A specific calculation method is as follows.

### Example 1

The wire resistance (per wire): 59.2Ω, the number of wires: 12, and the electrode resistance: 0.56Ω. From (59.2/12) Ω+0.56Ω, the value was calculated to be approximately 5.49Ω.

### Example 2

The wire resistance (per wire): 59.2Ω, the number of wires: 12, and the electrode resistance: 0.74Ω. From (59.2/12) Ω+0.74Ω, the value was calculated to be approximately 5.67Ω.

### Comparative Example 1

The wire resistance (per wire): 36.9Ω, the number of wires: 8, and the electrode resistance: 0.04Ω. From (36.9/8) Ω+0.04Ω, the value was calculated to be approximately 4.65Ω.

The difference rate between the actual measured value and the calculated value results from the contact resistance between the electrodes and the conductive linear bodies. Thus, a small difference rate between the actual measured value and the calculated value means a small contact resistance.

### Measurement of Elastic Modulus

The Young's modulus of the electrodes was measured by continuous stiffness measurement. Specifically, the Young's modulus at 25 degrees C. of the electrodes disposed on the glass base material was measured using Nano Indenter (produced by MTS Systems Corporation) under the following conditions. Table 1 shows the results obtained.

Indenter shape: triangular pyramid, Maximum pressing depth of indenter: 500 nm, Variation Frequency: 75 Hz

### Calculation of R/r Value

A specific method of calculating R/r is as follows.

### Example 1

The wire resistance (per wire): 59.2Ω, the number of wires: 12, and the electrode resistance: 0.56Ω. From 0.56Ω/(59.2/12)Ω, the value was calculated to be approximately 0.1135.

### Example 2

The wire resistance (per wire): 59.2Ω, the number of wires: 12, and the electrode resistance: 0.74Ω. From 0.74Ω/(59.2/12)Ω, the value was calculated to be 0.1500.

### Comparative Example 1

The wire resistance (per wire): 36.9Ω, the number of wires: 8, and the electrode resistance: 0.04Ω. From 0.04Ω/(36.9/8)Ω, the value was calculated to be approximately 0.0087.

TABLE 1

| | | | | | Difference |
|---|---|---|---|---|---|
| | | | | | Rate Between |
| | | | | | Actual |
| | | | | | Measured |
| | | | | Actual | Value and |
| | Young's | | Calculated | Measured | Calculated |
| | Modulus | | Value | Value | Value |
| | (Gpa) | R/r | (Ω) | (Ω) | (%) |
| Ex. 1 | 62.6 | 0.1135 | 5.49 | 5.50 | 0.2 |
| Ex. 2 | 24.0 | 0.1500 | 5.67 | 5.76 | 1.6 |
| Comp. 1 | 136.1 | 0.0087 | 4.65 | 5.60 | 20.4 |

The results shown in Table 1 indicate that when the Young's modulus of the electrode is in the range of more than 1×10⁹ Pa to 100×10⁹ or less (Examples 1 and 2), the difference rate between the actual measured value and the calculated value is smaller than that when the Young's modulus of the electrodes is excessively high (Comparison Example 1). This confirms that the invention can reduce the contact resistance between the conductive linear bodies and the electrodes.

Further, by comparing Example 1 with Example 2, it has been found that Example 1, in which the Young's modulus of the electrodes was relatively high and the electrodes were gold-plated, had a smaller difference rate between the actual measured value and the calculated value than Example 2.

### EXPLANATION OF CODES

1 . . . base material, 2 . . . pseudo sheet structure, 21 . . . conductive linear bodies, 3 . . . resin layer, 4 . . . electrodes, 5, 5′ . . . release film, 100 . . . wiring sheet

1. A wiring sheet comprising:
a pseudo sheet structure comprising a plurality of conductive linear bodies arranged at intervals; and
a pair of electrodes being in direct contact with the conductive linear bodies, wherein
a Young's modulus of the electrodes is in a range of more than 1×10⁹ Pa to 100×10⁹ Pa or less.

2. The wiring sheet according to claim 1, wherein a relationship between an axial resistance value R of the electrodes and an axial resistance value r for all the conductive linear bodies satisfies a condition represented by an expression (F1) below,
$$r > R \qquad ( F 1 )$$

3. The wiring sheet according to claim 1, wherein the electrodes have a thickness of 40 μm or less.

4. The wiring sheet according to claim 1, wherein the electrodes are gold-plated.

5. The wiring sheet according to claim 1, wherein the electrodes consist of a conductor having a Young's modulus in the range of more than 1×10⁹ Pa to 100×10⁹ Pa or less.

6. The wiring sheet according to claim 1, further comprising a resin layer supporting the pseudo sheet structure.

7. The wiring sheet according to claim 1, further comprising a base material supporting the pseudo sheet structure.

8. A method of producing the wiring sheet according to claim 1, the method comprising forming the pair of electrodes on the pseudo sheet structure such that the pair of electrodes are in direct contact with the conductive linear bodies, the pair of electrodes comprising a conductor having a Young's modulus in a range of more than 1×10⁹ Pa to 100×10⁹ Pa or less.
